(19) United States
(12) Patent Application Publication
(10) Pub. No.: US 2025/0086968 A1
(43) Pub. Date: Mar. 13, 2025

(54) SYSTEM AND METHOD OF FEATURE DETECTION IN SATELLITE IMAGES USING NEURAL NETWORKS

(71) Applicant: Department of Science and Technology - Advanced Science and Technology Institute, Quezon City (PH)

(72) Inventors: Joel Joseph S. Marciano, JR., Quezon City (PH); Roel M. de la Cruz, Quezon City (PH); Nestor T. Olfindo, JR., Quezon City (PH); Machele M. Felicen, Quezon City (PH); Marion Clarisse L. Gelido, Quezon City (PH); John Keithley Difuntorum, Quezon City (PH)

(21) Appl. No.: 18/957,432

(22) Filed: Nov. 22, 2024

Related U.S. Application Data
(63) Continuation of application No. 17/601,672, filed on Oct. 5, 2021, now abandoned.

(30) Foreign Application Priority Data
Apr. 6, 2020 (PH) 1-2020-050067

(51) Int. Cl. G06V 20/10; G06V 10/82

(52) U.S. Cl. CPC G06V 20/188; G06V 10/82

(57) ABSTRACT

The present invention generally relates to systems and methods of classification and localization of features of interest in remote aerial images. It relates particularly to a system and method of classifying and localizing features of interest on satellite images by semantic segmentation using a trained deep learning convolutional neural network. Increasing the accuracy of classification and localization requires that the neural network to decipher the difference between the feature of interest and other features in the background. This invention addresses the problem of low accuracy in classifying and localizing pixels corresponding to the feature of interest by enabling the user to include more information together with the original pixel values in the satellite images. An exemplary embodiment of this invention is a system and method of locating mango trees in a plantation in Bataan province, Philippines using a U-net convolutional network.

### TECHNICAL FIELD OF THE INVENTION

The present invention generally relates to systems and methods of classification and localization of features of interest in remote aerial images. It relates particularly to a system and method of classifying and localizing features of interest on satellite images by semantic segmentation using a trained deep learning convolutional neural network.

### BACKGROUND OF THE INVENTION

In the field of deep learning in computer vision, semantic segmentation is used to detect specific features of interest in digital images. For example, semantic segmentation of features corresponding to ships and airplanes in satellite images provide a way to track the route of these transport vessels. In a more common example, semantic segmentation is used by self-driving cars to identify objects in their surroundings whether these are humans, other cars, or a different object altogether to prevent unwanted collision. In medical images, certain features are detected automatically using semantic segmentation to provide for early diagnosis of life-threatening illnesses.

The challenge in automatic detection in these images is improving the accuracy of segmentation. This is addressed in the literature by different means. For example, CN110211137A provides a method of semantic segmentation in satellite images using a residual neural network followed by a u-net deep learning convolutional neural network to improve the accuracy of detecting marine vessels in the ocean. First, a residual neural network or ResNet 34 is constructed. A U-net is constructed thereafter. Training images are fed into the ResNet 34 for binary classification of pixels as to whether the pixel belongs to that of a marine vessel. Images wherein a marine vessel is found are fed into the U-net for binary segmentation. This process allows for a segmentation with high real-time performance and precision.

Another reference, CN108805874A, illustrates semantic segmentation on multispectral satellite image using a convolutional neural network. For the multispectral image, segmentation is improved by processing each component single band image into the convolutional neural network and then fusing feature maps obtained after processing individual bands. The method improves the segmentation precision and working efficiency.

CN104751162A provides another method of semantic segmentation in hyperspectral remote sensing image based on a convolution neural network. The method includes removing unnecessary bands, transforming, reconstructing, and pre-processing the hyperspectral original image, and acquiring standardized input data, performing convolution on the standardized input data by different filters through localized receptive fields, performing sub sampling on the convolution results, stacking the convolution layer and the sub sampling layer, acquiring standardized input image state response, and implementing the hyperspectral remote sensing image feature detection. This method enables a more efficient detection in hyperspectral image for post-processing purposes and overcoming high redundancy.

Increasing accuracy of classification and localization requires that the neural network to decipher the difference between the feature of interest and other features in the background. Although mere application of segmentation masks makes the neural network learn this difference, it may do so at a slow pace thereby contributing to a low detection accuracy.

### SUMMARY OF THE INVENTION

The invention is a system and computer-implemented method of classifying and localizing features in satellite images using a deep learning convolutional network. This invention addresses the problem of low accuracy in classifying and localizing pixels corresponding to the feature of interest by enabling the user to include more information together with the original pixel values in the satellite images. In multi-band satellite images, for example, the user provides, in another channel, remote sensing indices relevant to the feature of interest. Conversely, the user may also choose to remove bands from said multi-band images for the purpose of increasing accuracy.

### BRIEF DESCRIPTION OF THE DRAWINGS

FIG. 1 illustrates parts of an embodiment of the system pertaining to the invention specifically the location and features of interest as imaged by a remote imaging satellite.

FIG. 2 shows a pixel of the image corresponding to a feature of interest found in a location with said image stored in memory.

FIG. 3 shows computer-readable instructions being stored in memory.

FIG. 4 demonstrates the application of a segmentation mask on the stacked satellite image while geographic information system application is running in a processor of the central processing unit.

FIG. 5 demonstrates the stacking of satellite images to produce a multi-band satellite image using stacking script running in a processor of the central processing unit.

FIG. 6 illustrates how different pixels are compressed into a compressed file format.

FIG. 7 illustrates the use of an augmentation script executed in parallel among graphics processing units to increase the number of training images.

FIG. 8 is a diagram of the U-net architecture implemented for the neural network of this invention.

FIG. 9 illustrates the behavior of the accuracy measure relative to the number of epochs for the exemplary embodiment of the invention.

FIG. 10 illustrates the behavior of the loss function relative to the number of epochs for the exemplary embodiment of the invention.

### DETAILED DESCRIPTION OF THE INVENTION

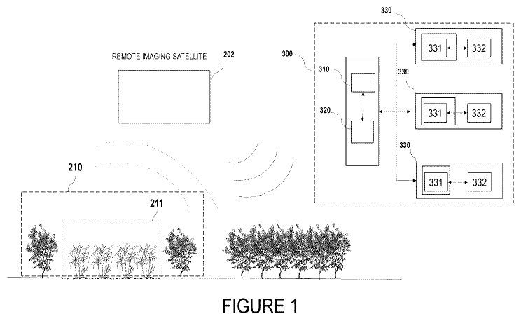

The present disclosure relates to systems and methods for improving detection accuracy in computer vision. With reference to FIG. 1, disclosed is a system for feature detection in satellite images comprising a computing structure (300) and satellite images (200) of a location (210) where feature of interest (211) is found. The computing structure (300) comprises a plurality of processors (311,331) and memory (320) that includes computer-readable instructions (321) executed in said processors (311,331) to train and establish neural network (380) for classifying and localizing pixels (201) in satellite images as belonging to feature of interest (211) and allow a user to remove from or include remote sensing indices (2012) with satellite images to improve classification and localization accuracy. In certain embodiments, the satellite images are satellite images (200) captured by a remote imaging satellite (202) chosen from the group of satellites consisting of WorldView-3, KOMPSat-3, GeoEye-1, Sentinel-2, Sentinel-3, SPOT-6, SPOT-7, CBERS-01, CBERS-02, ZY-102C, ZY-3, and LandSat-8.

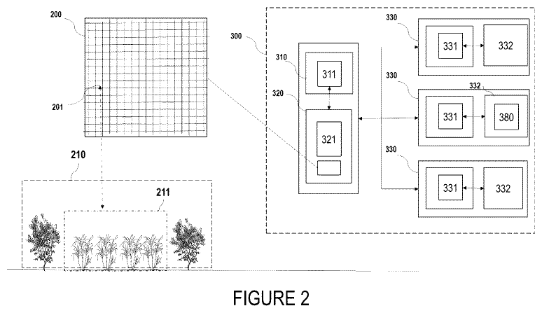

With reference to FIG. 2, the system, in certain embodiments, can be configured to detect pixels (201) corresponding to vegetation such as mango trees and help provide for the location (210) of said mango trees in a satellite image for surveying purposes. Additionally, the neural network (380) can be trained to detect built-up features such as but not limited to buildings or bridges, airports, runways, and other man-made structures for purpose of military surveillance. In general, the system (100) can be configured to detect vegetation, built-up features, land transport vessels, sea transport vessels, air transport vessels, clouds, cloud shadows, landforms, and bodies of water.

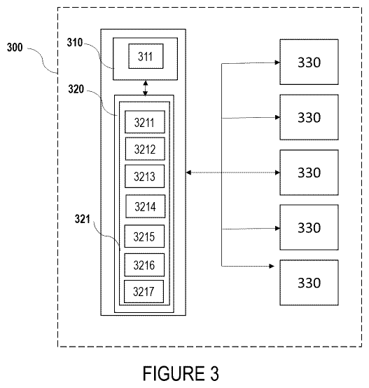

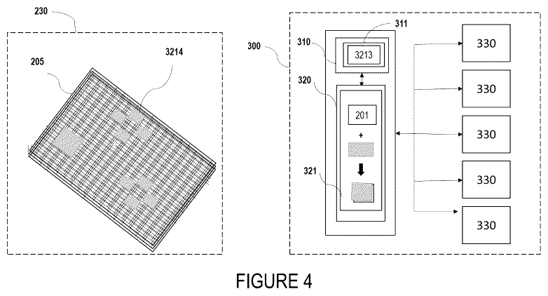

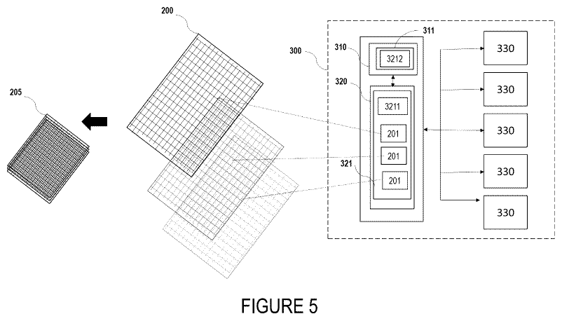

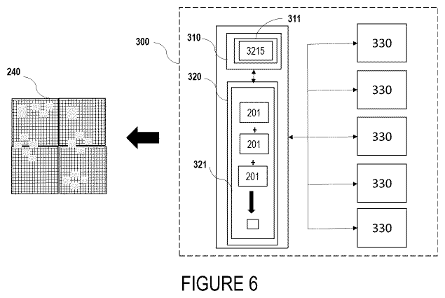

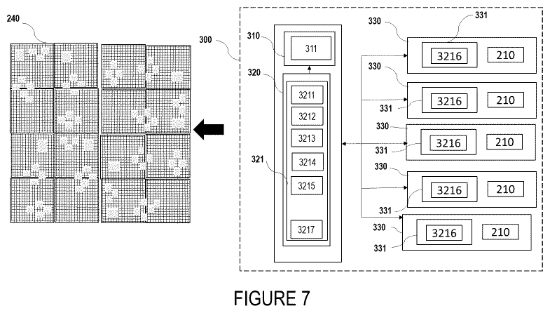

With reference to FIGS. 3-7, in some embodiments, the computer-readable instructions (321) include a pre-processing script (3211) to normalize satellite images (200) and remove certain effects in the image (200) ranging from atmospheric scattering, top of atmosphere reflectance, sea surface scattering, topographic effects, terrain effects, and radiometric effects, a stacking script (3212) to stack images (200) of different bands and create a stacked multi-band image (220), a geographic information system application (3213) executed in a processor (311) of computing structure (300) allowing a user to apply a segmentation mask (3214) on stacked multi-band satellite image (220) to create a training image (230), a caching script (3215) to compress created training image (230) into a compressed image (240) in hierarchical data format, and an augmentation script (3216) to increase the number of training images (230). Additionally, with the exception of the augmentation script (3216) that is executed in a processor (331) belonging to a graphics processing unit or GPU (330), all the recently mentioned inclusions (3211-3215) in the computer-readable instructions (321) are executed in a processor (311) belonging to a central processing unit (310).

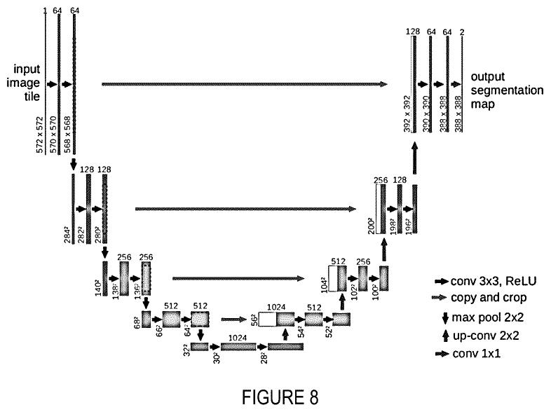

With reference to FIG. 8, in the exemplary embodiment of the system, the deep learning convolutional network of the system is of U-net architecture. A U-net deep learning convolutional network consists of an encoder path and a decoder path. The encoder path comprises a number of consecutive regular convolution and max pooling layers to gradually reduce the size of the image while increasing the number of channels thereby classifying the pixels as belonging to feature of interest. The decoder path, on the other hand, comprises a number of consecutive transpose convolution and regular convolution layers to up-sample the image and gradually decreasing the number of channels thereby localizing the pixel relative to the other pixels in the training image. This network is established by executing instructions in at least one processor belonging to a GPU. Regularization of the training image to avoid overfitting and accelerated convergence maybe achieved using a batch normalization script.

Because instructions for training, normalization, and prediction with validation images involve a lot of computing power, the deep learning convolutional network is implemented in a parallel computing structure (300) which includes a workload-scheduling means (3217) that assigns parallel execution of computer-readable instructions (321), monitors workload, and manage work queues among processors (331). Typically, the workload-scheduling means (3217) is a software or script that may be publicly available such as Slurm.

In the exemplary embodiment, the system enables a user to include together with a multi-band satellite image (205), a channel for the values of a remote sensing index such as but not limited to normal difference vegetation index or NDVI, normal difference water index, normal difference built-up index, soil-adjusted vegetation index, microwave vegetation index, enhanced vegetation index, or biological crust index depending on the purpose of the detection. For example, the user may include a channel for NDVI values into a 5-band (RGB, NIR, SWIR) satellite image (220) by calculating using a band calculation script the NDVI values from pixel values belonging to the red band and NIR band for the purpose of increasing the accuracy of segmenting vegetation of interest from the built-up features in the background. In a completely different example, a user may also remove from the 5-band satellite image (220), a specific band to improve detection accuracy of built-up features such as buildings.

The method of utilizing the above-described system begins with obtaining satellite images (200). In the exemplary embodiment, single-band satellite images (200) are obtained by satellite tasking and are subsequently normalized to reduce certain effects such as that of top of the atmosphere reflectance. Normalizing the satellite image is accomplished by using a pre-processing script (3211). The normalized images (209) are then stacked to create a multi-band satellite image (220). Training images (230) are generated from the multi-band satellite image (220) by applying a segmentation mask (3214) to delineate the feature of interest (211) from the background. At this point, the user may modify the training image (230) to include a channel (2013) for additional pixel information (2011). In the exemplary embodiment using multi-band satellite images (220), this step is accomplished using a band calculation script (3218) to include a channel for information such as that of remote sensing indices or remove a specific channel from the image depending on the purpose of detection. After modification, training images (230) are then cached or compressed using a caching script into a file with a hierarchical data format. To avoid overfitting, the number of training images is augmented using data augmentation techniques implemented with an augmentation script. These techniques include translating the image vertically or horizontally, flipping the image to create a mirror image, or rotating the image either clockwise or counterclockwise. Patches are then derived from the augmented images and these patches are used to iteratively train the deep learning convolutional network for it to learn the nuances of patches. Training is achieved with the automated adjusting of the weights and biases in the layers via backpropagation. In the exemplary embodiment, backpropagation is implemented every after training 200 patches. The trained network is then used to classify and localize pixels in validation images as belonging to feature of interest. The final output would then be a map showing the location of the feature of interest with the pixels delineated from the background. Above-described method applies to satellite images derived from remote imaging satellites selected from the group consisting of WorldView-3, KOMPSat-3, GeoEye-1, Sentinel-2, Sentinel-3, SPOT-6, SPOT-7, CBERS-01, CBERS-02, ZY-102C, ZY-3, and LandSat-8. It also applies to features of interest chosen from the group consisting of vegetation, built-up features, land transport vessels, sea transport vessels, air transport vessels, clouds, cloud shadows, landforms, and bodies of water.

In the exemplary embodiment, the deep learning convolutional network is of U-net architecture. Training a U-net begins with reading pixel information from patch of training image with specific dimensions. The training image goes through the encoder path comprising a number of regular convolution layers with a filter of certain dimensions is used to convolve the patch of training image. Afterwards, the convolved image goes through a max pooling layer with a specific stride and filter dimensions. Depending on the preference of the user, the last two steps are repeated for n number of iterations to create a hierarchy of n encoder levels until the image dimensions are gradually halved n times while the number of bands is doubled n times. From the encoder path, the image then gets up-sampled by applying transposed convolution layer to the image to double the dimension size and halve the number of bands. The up-sampled image is concatenated with the output of the encoder at the same level. The concatenated image then goes through a number of regular convolution layers with a filter of specific dimensions. The last two preceding steps are then repeated for n number of iterations until the image dimensions are gradually doubled n times while the number of bands is halved n times until original dimensions and number of bands is restored.

In certain embodiments, accuracy measures are calculated to estimate classification and localization accuracy of the deep learning convolutional network for the specified parameters.

In the exemplary embodiment, the system comprises multispectral images from satellites such as World-view 3, KompSAT-3, and Landsat-8 of a mango plantation in Bataan, Philippines, and a computing cluster comprising CPU and GPU-based computing nodes. The system is used to detect the location of mango trees in the satellite images. The computing cluster has specifications disclosed in https://asti.dost.gov.ph/coare/wiki/Main/. Moreover, computing cluster includes computer-readable instructions for the pre-processing of the satellite images such as adjusting for top of the atmosphere reflectance per band. It also includes instructions for stacking of the different images. Pre-processed satellite images with initial masks or outlines of features to be detected and classified are used for training data. Said instructions include GIS software for creation of masks for training data. Instructions also include a module to augment training data by mirror flipping and rotating images, another module to cache satellite images together with remote-sensing indices such as NDVI into an h5 file, and instructions to implement the neural network algorithm. Said neural network is deep learning convolutional and has a U-Net architecture implemented in GPU compute nodes. Final output is a satellite image with delineated pixels corresponding to that of wanted features identified.

The method implemented in the recently described exemplary embodiment comprises the steps of pre-processing satellite images for corrections per band, stacking pre-processed images, creating training data by outlining features to be detected using GIS software, augmenting the number of training data by mirror-flipping or rotating, caching augmented images into an h5 file together with remote sensing indices, reading of h5 file by neural network implemented in GPU compute node, training neural network with h5 file to determine weights and biases, and classifying pixels of validation h5 file using trained neural network.

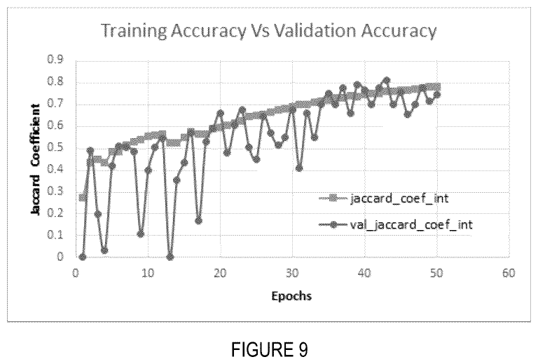

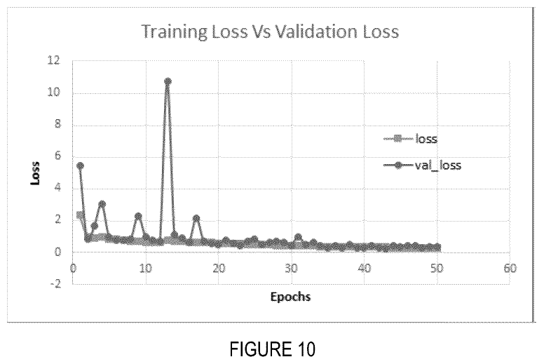

Furthermore, in the exemplary embodiment, the number of total images consists of 60% training images, 20% validation, and 20% for prediction. The loss function is a combination of binary cross entropy and Jaccard coefficient. With reference to FIG. 9, both the training and validation Jaccard coefficient approach the value of 1 with increasing epochs. FIG. 10 illustrates a decreasing entropy loss with the increasing epochs.

The preferred embodiments of this invention are described in the above-mentioned detailed description. It is understood that those skilled in the art may conceive modifications and/or variations to the embodiments shown and described therein. Any such modifications or variations that fall within the purview of this description are intended to be included therein as well. Unless specifically noted, it is the intention of the inventors that the words and phrases in the specification and claims be given the ordinary and accustomed meaning to those of ordinary skill in the applicable art. The foregoing description of the preferred embodiments and best mode of the invention known to the applicant at the time of filing the application have presented and are intended for the purposes of illustration and description. These are not intended to be exhaustive or to limit the present invention to the precise forms disclosed, and many modifications and variations are possible in the light of the above teachings.

1. A system for feature detection in satellite images using neural network comprising:
satellite images of a location where feature of interest is found; and
a computing structure further comprising:
a plurality of processors; and
memory that includes computer-readable instructions executed in said processors to train and establish a deep learning convolutional network for classifying and localizing pixels in the satellite images as belonging to feature of interest;
wherein said instructions enable the removal of bands from or inclusion of remote sensing indices with satellite images to improve classification and localization accuracy.

2. The system of claim 1 wherein said satellite images are multi-band satellite images captured by a remote imaging satellite.

3. The system of claim 2 wherein said remote imaging satellite is chosen from the group of satellites consisting of WorldView-3, KOMPSat-3, GeoEye-1, Sentinel-2, Sentinel-3, SPOT-6, SPOT-7, CBERS-01, CBERS-02, ZY-102C, ZY-3, and LandSat-8.

4. The system of claim 2 wherein said computer-readable instructions include a pre-processing script executed in a processor of computing structure to normalize multi-band satellite images and remove certain effects in the image.

5. The system of claim 4 wherein said effect is chosen from the group consisting of atmospheric scattering, top of atmosphere reflectance, sea surface scattering, topographic effects, terrain effects, and radiometric effects.

6. The system according to claim 4 wherein said processor belongs to a central processing unit.

7. The system of claim 1 wherein said computer-readable instructions include a stacking script executed in a processor of computing structure to stack images of different bands and create a stacked multi-band image.

8. The system of claim 1 wherein said computer-readable instructions include a geographic information system application executed in a processor of computing structure allowing a user to apply a segmentation mask on multi-band satellite image to create a training image.

9. The system of claim 8 wherein said computer-readable instructions further include a caching script executed in a processor of computing structure to compress created training image into a compressed image in hierarchical data format.

10. The system of claim 9 wherein said computer-readable instructions further include an augmentation script executed in at least one processor to increase the number of training images.

11. The system of claim 1 wherein said deep learning convolutional network is of U-net architecture.

12. The system of claim 11 wherein said U-net deep learning convolutional network comprises:
an encoder path further comprising a number of consecutive regular convolution and maxpooling layers to gradually reduce the size of the image while increasing the depth thereby classifying the pixels as belonging to feature of interest; and
a decoder path further comprising a number of consecutive transpose convolution and regular convolution layers to upsample the image and gradually decreasing depth thereby localizing the pixel relative to the other pixels in the training image.

13. The system of claim 12 wherein the instructions include a batch normalization script for accelerated convergence during training and avoid overfitting.

14. The system of claim 1 wherein said computing structure includes workload-scheduling means that when executed in any of the processors assigns parallel execution of computer-readable instructions, monitors workload, and manage work queues among processors.

15. The system of claim 1 wherein said feature of interest is chosen from the group consisting of vegetation, built-up features, land transport vessels, sea transport vessels, air transport vessels, clouds, cloud shadows, landforms, and bodies of water.

16. The system of claim 1 wherein said remote sensing indices are chosen from the group consisting of normal difference vegetation index, normal difference water index, normal difference built-up index, soil-adjusted vegetation index, microwave vegetation index, enhanced vegetation index, or biological crust index.

17. The system according to claim 1 wherein said processors executing instructions to train and implement deep learning convolutional neural network belong to a graphical processing unit.

18. A computer-implemented method of classifying and localizing features in satellite images implemented in the system described according to claim 1, said method comprising the steps of:
a. normalizing satellite image of a single band using a pre-processing script to remove certain effects in the image;
b. stacking normalized multiple single-band satellite images using a stacking script to create a multi-band satellite image;
c. applying a segmentation mask to multi-band image using geographic information system application to generate training image;
d. modifying the generated training image using a band calculation script;
e. caching a set of modified training images using a caching script to compress training image into a hierarchical data format;
f. augmenting the compressed training image using data augmentation techniques implemented with an augmentation script to increase the number of training images;
g. iteratively training the deep learning convolutional network with a specific number of patches of augmented images implemented to learn the nuances of patches thereby creating a trained neural network whose weights and biases have been modified by backpropagation;
h. classifying pixels in validation images as belonging to feature of interest using the trained neural network to create a final output image showing location of features of interest;
wherein said step of modifying the generated training image uses a band calculation script to remove bands or information such as but not limited to remote sensing indices in said training image for the purpose of improving the classification and localization accuracy of pixels belonging to feature of interest.

19. The method of claim 18 further comprising the step of transferring single-band satellite images of a location of interest via a communication protocol from the remote imaging satellite by satellite tasking.

20. The method of claim 18 wherein said remote imaging satellite is selected from the group consisting of WorldView-3, KOMPSat-3, GeoEye-1, Sentinel-2, Sentinel-3, SPOT-6, SPOT-7, CBERS-01, CBERS-02, ZY-102C, ZY-3, and LandSat-8.

21. The method of claim 18 wherein said feature of interest is chosen from the group consisting of vegetation, built-up features, land transport vessels, sea transport vessels, air transport vessels, clouds, cloud shadows, landforms, and bodies of water.

22. The method of claim 18 wherein said step of augmenting the compressed training image further comprise the steps of:
a. rotating the training image either clockwise or counterclockwise;
b. translating the training image to a certain direction;
c. flipping the training image to create a mirror image; and
d. capturing a patch of the flipped, translated, or rotated training image.

23. The method of claim 18 wherein said deep learning convolutional network is of U-net architecture.

24. The method of claim 23 wherein said step of iteratively training the deep learning convolutional network further comprises the steps of:
a. reading pixel information from patch of training image of specific dimensions;
b. convolving patch of training image using a number of regular convolution layers with a filter of specific dimensions;
c. max pooling the convoluted patch with a specific stride and filter dimensions;
d. repeating the last two steps for n number of iterations essentially creating a hierarchy of n encoder levels until the image dimensions are gradually halved n times while the number of bands is doubled n times;
e. up-sampling by applying transposed convolution to the image to double dimension size and halving the number of bands;
f. concatenating up-sampled image with output of encoder of the same level;
g. convolving concatenated image using a number of regular convolution layers with a filter of specific dimensions; and
h. repeating the last two steps for n number of iterations until the image dimensions are gradually doubled n times while the number of bands is halved n times until original dimensions and number of bands is restored.

25. The method of claim 18 further comprising the step of calculating accuracy measures of classifying and localizing the feature of interest.
